(19) United States
(12) Patent Application Publication
(10) Pub. No.: US 2008/0228523 A1
(43) Pub. Date: Sep. 18, 2008

(54) Permanent weight management

(76) Inventor: Ralph DeRienz, Woodbury, CT (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/008,255

(22) Filed: Jan. 8, 2008

Related U.S. Application Data
(60) Provisional application No. 60/879,502, filed on Jan. 8, 2007.

(51) Int. Cl. G06Q 50/00; G01G 1/26; G09B 19/00

(52) U.S. Cl. 705/2; 177/235; 434/127

(57) ABSTRACT

The present invention is directed to a method for providing a permanent weight management program, and a kit for providing the permanent weight management program. The method includes obtaining health related information of an individual, obtaining at least one goal of the individual related to the health related information, identifying health related habit information that is contrary to the at least one goal of the individual, providing the individual with a permanent weight management plan that includes at least one corrective action with respect to the identified health related habit information and a focus object, and associating the at least one corrective action with the focus object so that the focus object provides a constant reminder to the individual to stay focused on making good lifestyle choices most of the time related to the at least one corrective action.

### CROSS REFERENCE TO RELATED APPLICATIONS

This application claims the benefit of U.S. Provisional Application No. 60/879,502, filed Jan. 8, 2007.

### FIELD OF THE INVENTION

The present invention relates to the field of improving the health of individuals, and more particularly to the field of permanent weight management.

### BACKGROUND OF THE INVENTION

Obesity is the most prevalent nutritional disorder in the United States. While genetic factors contribute towards the predisposition of obesity, the current environment of increased food intake and decreased energy expenditure is also a large contributing factor. Some factors attributable for the increased energy intake are advertisements for low priced and high-energy dense foods, marketing of larger portion sizes, increased frequency of restaurant meals, and use of more fast-foods. Some factors associated with decreased energy expenditure are labor saving devices; working at a job that is sedentary; decreased physical activity related to watching television, playing videogames, and using the computer. Prevention of obesity is frequently attempted through educational approaches aimed at improving knowledge and motivation, with consequent presumed impact on individual lifestyle choices.

Small changes may have a large impact on weight management, which in turn, can lead to the resolution or prevention of further progression of heart disease, diabetes, and the stigma of obesity. An effective weight management tool should be geared towards behavior change in exercise and eating habits. Successful weight loss requires motivation and guidelines that help people make appropriate every-day decisions. However, often short term weight loss is followed by regaining of weight as an individual returns to old habits and routines. As a result, many weight loss or control programs only offer short term solutions. Accordingly, what is needed is a weight management program that offers healthy eating and lifestyle modifications so that the individual learns to avoid the habits that caused them to be overweight, and develops habits that will help them maintain a healthy weight for life.

### SUMMARY OF THE INVENTION

In accordance with a first aspect of the present invention, a method for providing a permanent weight management program provided. The method includes obtaining health related information of an individual, obtaining at least one goal of the individual related to the health related information, identifying health related habit information that is contrary to the at least one goal of the individual providing the individual with a permanent weight management plan that includes at least one corrective-action with respect to the identified health related habit information and a focus object; and associating the at least one corrective action with the focus object so that the focus object provides a constant reminder to the individual to stay focused on making good lifestyle choices most of the time related to the at least one corrective action.

In accordance with the first aspect of the invention, the health related information includes the weight of the individual, and the at least one goal is weight loss for the individual.

In accordance with the first aspect of the invention, obtaining health related information of the individual includes obtaining at least a portion of medical history of the individual, obtaining at least one physical measurement of the individual, and obtaining at least one health related habit of the individual.

In accordance with the first aspect of the invention, the method may also include providing the individual with a journal to record at least one activity related to the health related information of the individual.

In accordance with the first aspect of the invention, the focus object comprises a coin engraved with the word “focus”.

In accordance with the first aspect of the invention, the permanent weight management plan includes providing the individual with vitamin and mineral information, water consumption information, or nutrition information.

In accordance with the first aspect of the invention, the health related habit information; includes food consumption of the individual or physical activity of the individual.

In accordance with the first aspect of the invention, the at least one corrective action includes one or more of the following: an eating plan, a meal selection plan, a meal preparation plan, an exercise plan, or a combination thereof.

In accordance with the first aspect of the invention, the method may also include providing a healthy eating plan consisting of a variety of nutritional foods in moderate proportions, or guidance to help the individual make the lifestyle changes and learn skills required to manage their new healthy weight for life, or a combination thereof.

In accordance with the first aspect of the invention, the method may also include providing personalized contact with the individual, or providing weekly telephone calls with the individual, or providing support and motivation thought mail and email contact, or some combination thereof.

In accordance with the first aspect of the invention, the method may also include teaching the individual one or more of the following: sound nutritional practices such as what foods should be eaten on a regular basis in order to insure good health, or how to select and shop for high quality foods they need, what foods to buy, or how to select the best and freshest foods, or how much food they need to purchase depending on how many people they intend to feed and how often they intend to go shopping, or some combination thereof.

In accordance with the first aspect of the invention, the at least one physical measurement comprises an image of the individual, a weight for the individual, and at least one measurement for the neck, waist, full hip, chest; thigh, calf or arm of the individual.

In accordance with the first aspect of the invention, the method may also include providing weekly contact for a predetermined period of time to keep the individual motivated, to remind the individual about the reasons why they need to lose weight and how weight loss will hopefully improve their health and the quality of their lives in the future, and to support the individual to feel that they are not alone and that they can get answers to their questions in a timely fashion.

In accordance with a second aspect of the invention, a method for providing permanent weight management for an individual is provided, and the method may include obtaining at least a portion of medical history of an individual, obtaining at least one physical measurement of the individual, obtaining at least one health related habit of the individual, obtaining at least one goal of the individual related to at least one of the medical history, the at least one physical measurement, or the at least one health related habit of the individual, identifying at least one health related habit of the individual that is contrary to the at least one goal of the individual, providing the individual with a permanent weight management plan that includes a journal to record at least one activity related to the at least one health related habit, at least one corrective action with respect to the health related habit and a focus coin, and associating the at least one corrective action with the focus coin so that the focus coin provides a constant reminder to the individual to stay focused on making good lifestyle choices most of the time related to the at least one corrective action.

In accordance with the second aspect of the invention, the health related information includes the weight of the individual and the at least one goal is weight loss for the individual.

In accordance with the second aspect of the invention, obtaining at least one a physical measurement of the individual comprises: obtaining at least one image of the individual, obtaining a weight for the individual, and obtaining a measurement for at least one body part of the individual selected from neck, waist, full hip, chest, thigh, calf or arm.

In accordance with the second aspect of the invention, obtaining at least one health related habit of the individual comprises: obtaining information related to consumption of food items by the individual, and obtaining information related to at least one physical activity of the individual.

In accordance with the second aspect of the invention, providing the individual with a permanent weight management plan comprises: providing the individual with vitamin and mineral information, providing the individual with water consumption information, and providing the individual with nutrition information.

In accordance with the second aspect of the invention, the at least one corrective action includes one or more of the following: an eating plan, a meal selection plan, a meal preparation plan, an exercise plan, or a combination thereof.

In accordance with the second aspect of the invention, the at least one corrective action is designed to reduce a number of times that the individual performs the at least one identified-health related habit.

In accordance with the second aspect of the invention, the journal is configured to receive information related to daily food intake, daily water intake, weight, physical measurements and comments of the individual.

In accordance with a third aspect of the present invention, a method for providing a permanent weight management program is provided, and the method may include obtaining at least a portion of medical history of an individual, obtaining at least one physical measurement of the individual, obtaining at least one health related habit of the individual, wherein the at least one health related habit is food consumption by the individual, or physical activity of the individual, or both, obtaining at least one goal of the individual related to at least one of the medical history, the at least one physical measurement, or the at least one health related habit of the individual, or some combination thereof, identifying at least one health related habit of the individual that is contrary to the at least one goal of the individual, providing the individual with a permanent weight management plan that includes a journal configured to receive information related to daily food intake, daily water intake, weight, physical measurements and comments of the individual, one or more corrective actions, including one or more of the following: an eating plan, a meal selection plan, a meal preparation plan, an exercise plan or a combination thereof, designed to impact the at least one health related habit of the individual that is contrary to the at least one goal of the individual, and a focus coin, and associating the one or more corrective actions with the focus coin so that the focus coin provides a constant reminder to the individual to stay focused on making good lifestyle choices most of the time related to the one or more corrective actions.

In accordance with a fourth aspect of the present invention, a kit for providing a permanent weight management program for an individual is provided, and the kit may include a focus coin, and an instruction sheet setting forth steps of the permanent weight management program, including: obtaining a weight of the individual, obtaining at least one goal related to weight loss for the individual, identifying health related habit information that is contrary to the at least one goal of the individual, providing the individual with at least one corrective action with respect to the health related habit information, and associating the at least one corrective action with the focus coin so that the focus coin provides a constant reminder to the individual to stay focused on making good lifestyle choices most of the time related to the at least one corrective action.

In accordance with the fourth aspect of the invention, the kit may also include a bathroom scale for the individual to weigh themselves, or a kitchen food scale for the individual to weigh food they consume, or a journal configured to receive information related to daily food intake, daily water intake, weight, physical measurements and comments of the individual, or a pedometer configured for determining an amount of movement the individual makes, or a tape measure for the individual to measure themselves, or some combination thereof.

In accordance with the fourth aspect of the invention, the bathroom scale is configured to display the weight, a body fat percentage and a hydration level of the individual.

### BRIEF DESCRIPTION OF THE DRAWINGS

The aforementioned features and advantages of the invention as well as additional features and advantages thereof will be more clearly understood hereinafter as a result of a detailed description of embodiments of the invention when taken in conjunction with the following drawings. In which:

FIG. 1 shows an exemplary method of providing a permanent weight management program according to the present invention.

FIG. 2 shows an exemplary implementation of the permanent weight management program according to the present invention.

FIG. 3a shows a view from the convex side of an exemplary focus object.

FIG. 3b shows a perspective view of the exemplary focus object.

FIG. 3c shows a view from the concave side of the exemplary focus object.

FIG. 3d shows a perspective view of the exemplary focus object.

FIGS. 4a-4b show an example of how the exemplary focus object may be held by an individual.

FIG. 5a shows an exemplary cover of a journal that may be used in the permanent weight management program according to the present invention.

FIG. 5b shows an exemplary page of the journal that may be used in the permanent weight management program according to the present invention.

FIG. 6 shows an exemplary datasheet that may be used to record an individual's body measurements.

### DETAILED DESCRIPTION OF THE INVENTION

The present invention is directed to a permanent weight management program of healthy eating and lifestyle modifications. The present invention provides a method for providing the permanent weight management program that is intended to help individuals reach a healthy weight; and to help individuals participating in the program make the lifestyle changes and learn, the skills required to manage their new healthy weight for life. Throughout the present application the individual participants in the permanent weight management program may be referred to as “weight managers,” as they are considered to be managing their weight. The permanent weight management program may be delivered through a combination of personalized contacts with the weight managers, combined with telephone calls, mail and/or email contacts. The personalized contacts with the weight managers may be in the form of face-to-face visits to the weight manger's residence or place of business or face-to-face meetings with the weight mangers at other locations. The personalized contacts may also be made through use of video or audio cassettes, digital video disks (DVDs), compact disks (CD) or other suitable media that can be used to record a personalized message to the weight managers. The telephones calls to the weight mangers may be made on a periodic basis, for example on a weekly basis.

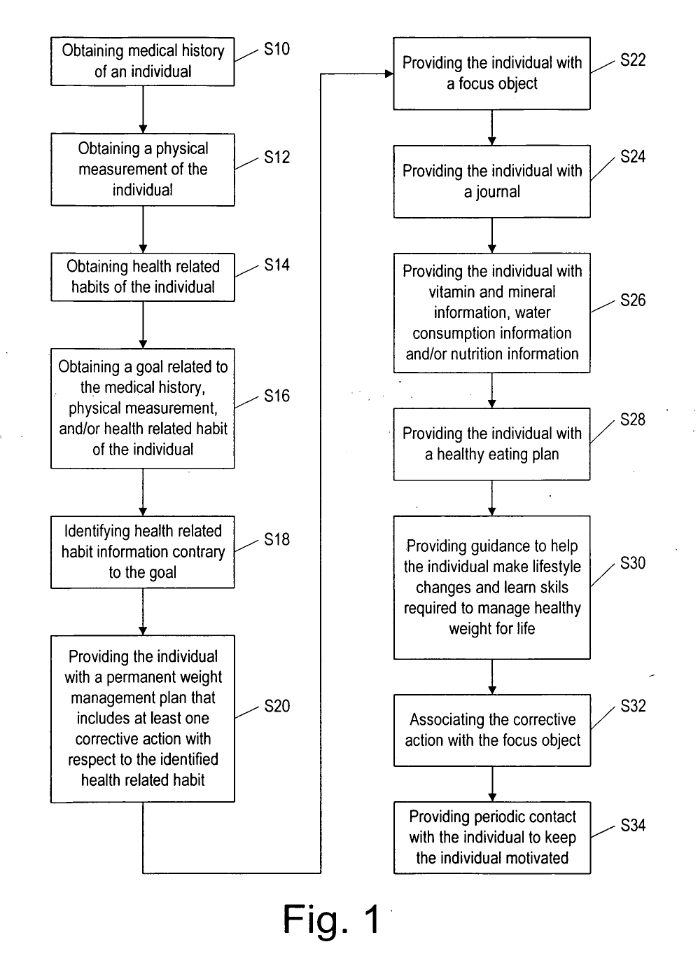

FIG. 1 provides the steps that may be involved in providing the permanent weight management program to an individual, i.e. a weight manager. The method of providing the permanent weight management program may include obtaining health related information of the individual, and obtaining health related information may include a step S10 of obtaining at least a portion of the medical history of the individual. The medical history of the individual may be related to medical operations or procedures the individual has had or is planning on having in the future, the medications that the individual has taken or is currently taken, any diseases or conditions, either physical or mental, that the individual is suffering from or has suffered from in the past. The medical history of the individual may also include allergies or special dietary needs of the individual.

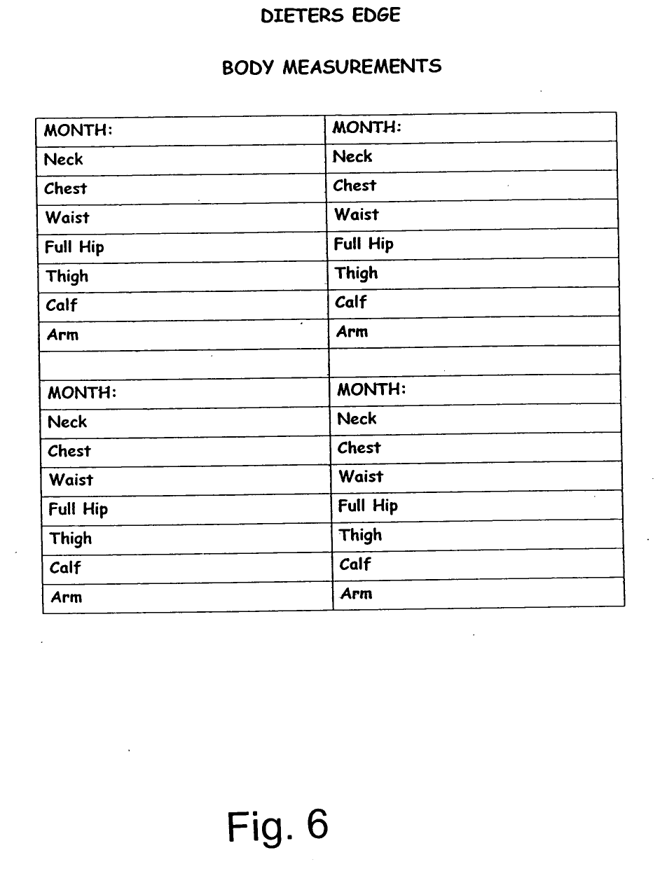

Health related information for the individual may also be physical measurements of the individual, and the method may also include a step S12 of obtaining physical measurements of the individual. The physical measurements for the individual may be a weight of the individual, or body measurements for the individual's neck, chest, waist, full hip, thigh, calf and/or arm. The physical measurements of the individual may be recorded on a form such as the one shown in FIG. 6. The physical measurements may be recorded periodically throughout the program in order to determine the progress of the individual. The physical measurements for the individual may also be in the form of a picture or image of the individual. Health related information for the individual may also be a health related habit of the individual, and the method may also include a step S14 of obtaining health related habits of the individual. The health related habits may relate to food consumption by the individual, for example what types of foods the individual normally eats, how much food is consumed by the individual, and how often the individual eats. The health related habit may also be related to the type physical activities that the individual performs, or the amount of physical activities that the individual participates in. For example, the step S14 of obtaining health related habits of the individual may include determining whether the individual is currently on any sort of exercise plan, and generally what is the individual's physical activity level.

The method shown in FIG. 1 may also include a step S16 of obtaining a goal related to the health related information of the individual, i.e. the information obtained that is related to the medical history, physical measurement or measurements, and/or health related habits of the individuals. For example, the goal may be weight loss for the individual. Using the goal of weight loss as an example, this goal is related to the medical history of the individual since it may affect the current and future medical needs of the individual. The goal of weight loss is related to the physical measurements of the individual since weight loss generally has an impact on the weight and size of an individual. Furthermore, the goal of weight loss is related to the health related habits of the individual because the individual may need to modify the health related habits in order to achieve the weight loss goal.

The method shown in FIG. 1 may also include a step S18 of identifying at least one health related habit that is contrary to the at least one goal. Contrary refers to the situation in which if the individual continues with the health related habit obtaining the individual's goal may be difficult or significantly hindered since the health related habit is generally considered to be counter-productive to the individual's goal. For example, if the individual's goal is weight loss, continuing with a physically inactive and mostly sedentary lifestyle may be counter-productive to the individual's weight loss goal. Establishing a healthy lifestyle is an important part of achieving the individual's long term goals under the permanent weight management program according to an aspect of the present invention. The intent is to prevent the individual from losing weight, and then returning to the same old habits that caused the individual to be overweight originally. The method according to the present invention includes helping the individual to examine the things that they do or do not do everyday that causes them to be overweight. Once the causes are identified changes can be made to what they do daily, to insure that after they reach a healthy weight they will be able to manage that weight for life.

The method shown in FIG. 1 may also include a step S20 of providing the individual with a-permanent weight management plan that includes at least one corrective action with respect to the identified health related habit. The corrective action may include one or more of an eating plan, a meal selection plan, a meal preparation plan, an exercise plan, or a combination thereof. For example, the corrective action may include teachings the individual sound nutritional practices such as what foods should be eaten on a regular basis in order to ensure good health, how to select and shop for high quality foods the individual needs, what type of foods to buy, how to select the best and freshest foods, how much food the individual needs to purchase depending on how many people they intend to feed and how often they intend to go shopping, or some combination thereof. For example, if an individual intends to feed a family of four a dinner with fish as the main course, the individual will need about 4 ounces of fish per person after cooking, so the individual will need to purchase approximately 1 and one-quarter to 1 and one-half pounds of fish. The corrective action may also include informing the individual about correct measuring and portioning of food, strategies for dinning out and parties, and recognizing and controlling emotional eating.

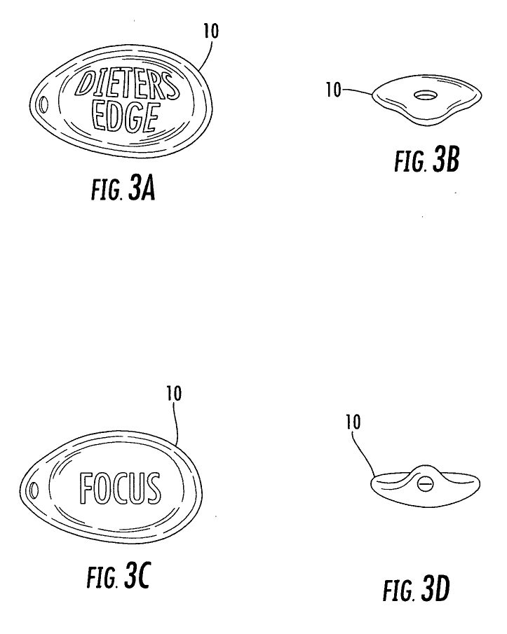

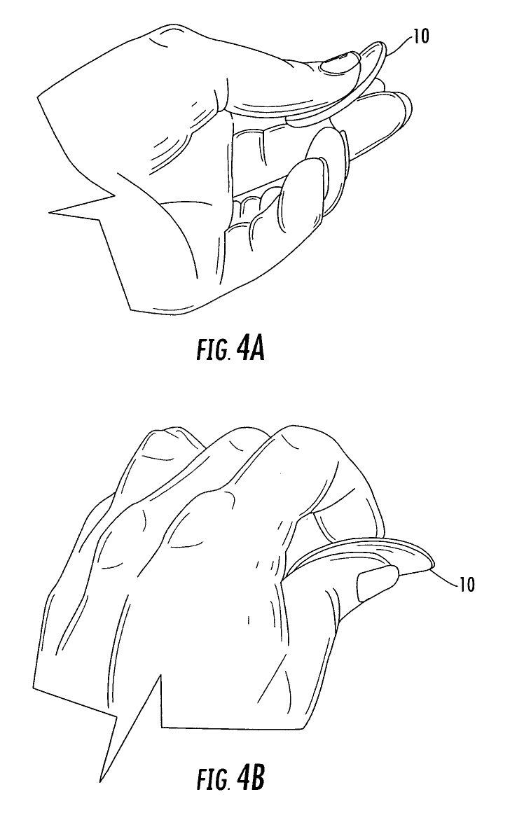

The method shown in FIG. 1 may also include a step S22 of providing the individual with a focus object. The focus object may be a focus coin 10 as shown in FIGS. 3a-3d. FIG. 3c demonstrates that the focus coin 10 may be inscribed with the term “FOCUS” on one of its surfaces. The focus coin 10 may be shaped like the end of a spoon, or like a lure used in fishing. The focus coin 10 may be pewter or any other alloy or elemental metal such as aluminum, silver or tin, or any hard plastic, ceramic, stone or other composite material. The term “FOCUS” may be engraved on the concave surface of the focus coin 10, on the opposite surface another phase or term may be engraved, for example the brand name of the permanent weight management program. FIGS. 4a and 4b show how the focus coin 10 may be held by the individual. It is understood that the focus object may also be comprised of any other suitable object or device, and that the focus coin 10 is merely an exemplary embodiment of the focus object.

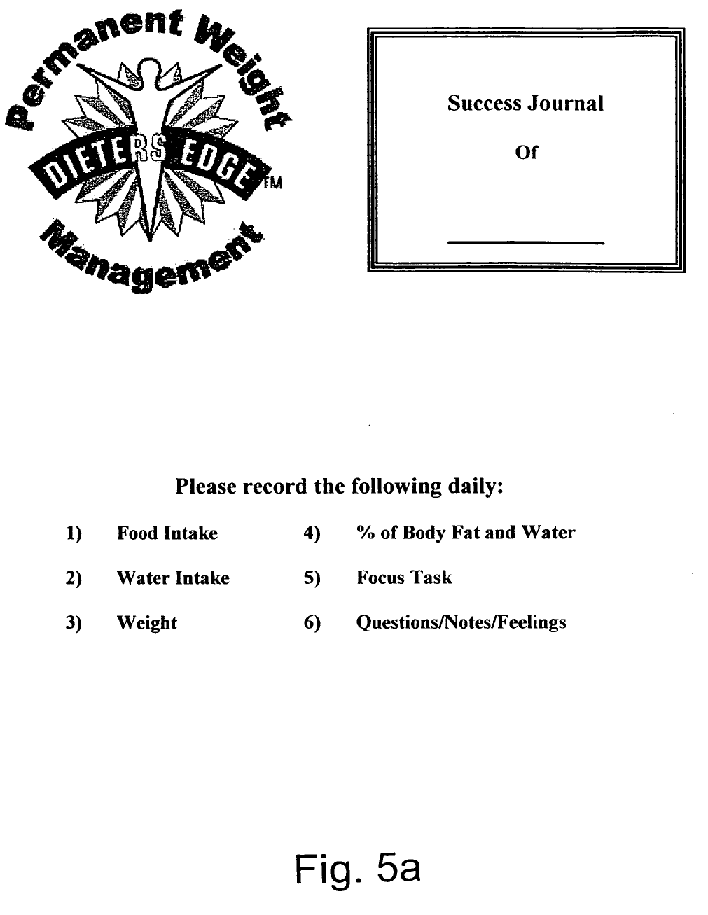

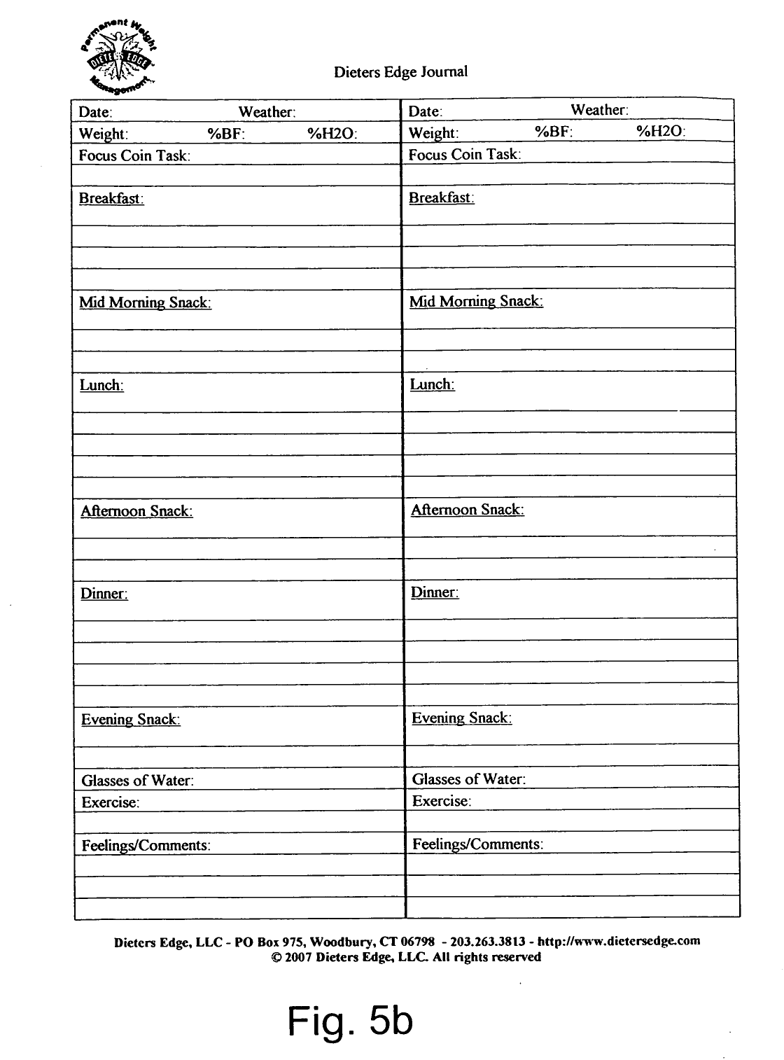

The method shown in FIG. 1 may also include a step S24 of providing the individual with a journal to record at least one activity related to at least one health related habit of the individual. The journal is configured to receive information related to daily food intake, daily water intake, weight, physical measurements and comments of the individual. In an exemplary embodiment of the invention the journal may have a cover as shown in FIG. 5a. The cover may instruct the individual to record the following on a daily basis: food intake, water intake, weight, percent of body fat and water, focus task and questions, notes and/or feelings. The journal may include entry forms as shown in FIG. 5b for the individual to record this information.

The method shown in FIG. 1 may also include a step S26 of providing the individual with vitamin and mineral information, water consumption information and/or nutrition information. The method may also include a step S28 of providing the individual with a healthy eating plan. The method may also include a step S30 of providing guidance to help the individual make lifestyle changes and learn skills required to, manage healthy weight for life. The lifestyle changes may be related to the corrective action of the permanent-weight management plan provided in step S20. For example, in accordance with step S30 the corrective action is intended not to be a one time action, but rather an ongoing lifestyle change for the individual in order to help the individual achieve the goal, i.e. weight loss, identified in step S16, and maintain that goal for the duration of the individual's lifetime. Motivation and support are extremely important parts of any weight loss program. Reaching a healthy weight can be a difficult process, and finding the motivation and keeping that motivation is important to long term success. Step S30 may include reminding the individual of the reasons why they need to lose weight, and how the weight loss will hopefully improve their health and the quality of lives in the future.

As shown in FIG. 1, the method may also include a step S32 of associating the corrective action with the focus object, for example the focus coin 10, so that the focus object provides a constant reminder to the individual to stay focused on making good lifestyle choices most of the time related to the at least one corrective action. For example, the individual may be instructed to rub the focus object whenever they are tempted to make a poor choice or when they feel stressed and need to settle themselves. As an additional example, the focus object, i.e. focus coin 10, may be used before a party or gathering as a way to remind the individual that they need to make good choices in the food or drink that they select.

The method shown in FIG. 1 may also include a step S34 of providing periodic contact, for example weekly contact, with the individual to keep the individual motivated. The contact may be in the form of face-to-face meetings with the individual, messages recorded on some form of media, i.e. cassette tapes or DVDs, telephone calls, or mail and email. The contact may also be bi-weekly, monthly or yearly depending on the needs of the individual. The periodic support through the contacts helps them feel that the individual is not alone, and that the individual can get answers to their questions in a timely fashion. The period contact provides away to inform the individual that they are doing things correctly so that they will feel more comfortable, and thereby increase the chances of their success.

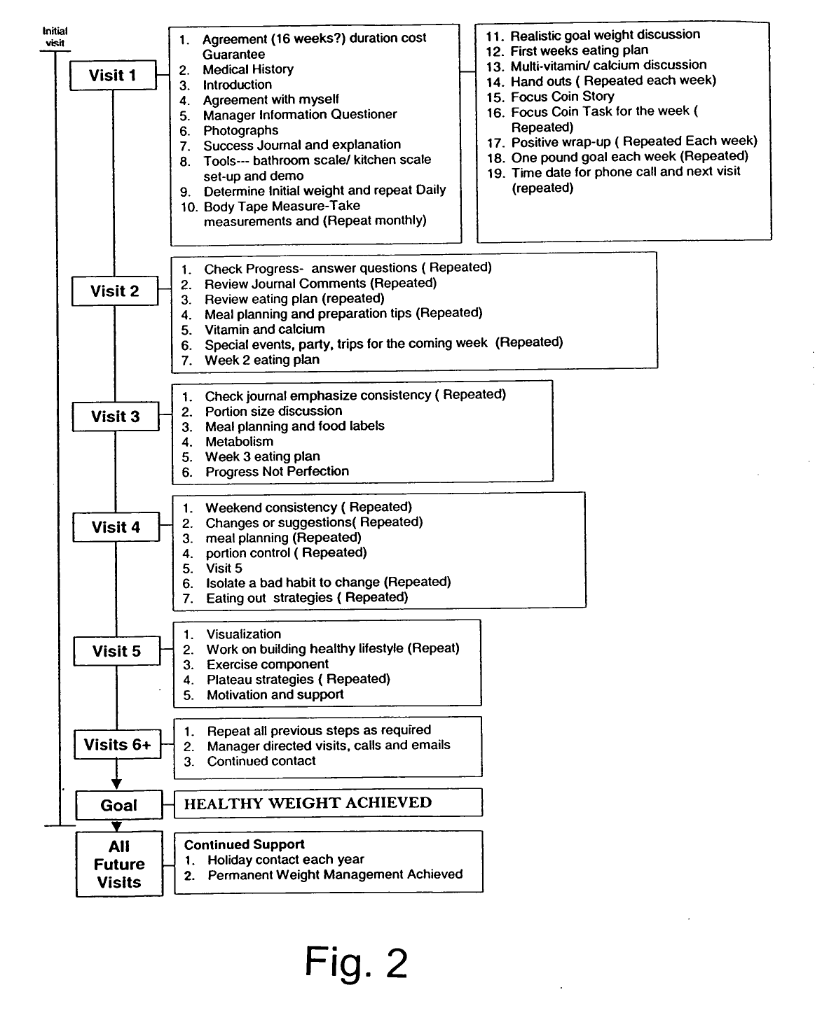

FIG. 2 shows an exemplary implementation of the method shown in FIG. 1, broken down into visits with the individual. For example, in Visit 1 health related information, i.e. medical history and physical measurements are obtained. As shown in FIG. 2, the method of the present invention of providing a permanent weight management program may include the activities shown for each of the Visits, and the activities may be repeated as many times as necessary. In addition, it is understood that the activities may be performed in other orders than those shown in FIGS. 1 and 2.

The permanent weight management program according to the present invention is designed to control blood sugar, prevent diabetes and its complications, manage a healthy cholesterol level, maintain a healthy blood pressure, reduce the need for medications, improve health and mobility, reduce the signs of aging, help the individual look and feel younger, save money on medications and doctor visits, improve the quality of the individual's sex life, allow the individual to feel more confident about his/her appearance; reduce the risk of heart-disease and stroke, reduce the risk of cancers, reduce or eliminate sleep apnea, ease the pressure on joints and reduce arthritis pain allow the individual to move around and breathe easier, and enjoy life to the fullest in a healthy body.

In accordance with another exemplary embodiment of the invention, a kit for providing a permanent weight management program for an individual is also provided The kit may include a focus coin, for example as shown in FIGS. 3a-3d, or other focus object, and an instruction sheet setting forth steps of the permanent weight management program. The steps of the permanent weight management program may include obtaining a weight of the individual, obtaining at least one goal related to weight loss for the individual, identifying health related habit information that is contrary to the at least one goal of the individual, providing the individual with at least one corrective action with respect to the health related habit information, and associating the at least one corrective action with the focus coin so that the focus coin provides a constant reminder to the individual to stay focused on making good lifestyle choices most of the time related to the at least one corrective action.

The kit may also include a bathroom scale for the individual to weigh themselves, or a kitchen food scale for the individual to weigh food they consume, or a journal configured to receive information related to daily food intake, daily water intake, weight, physical measurements and comments of the individual, or a pedometer configured for determining an amount of movement the individual makes, or a tape measure for the individual to measure themselves, or some combination thereof. The bathroom scale is configured to display the weight, a body fat percentage and a hydration level of the individual.

One skilled in the relevant art will further recognize that many possible modifications and combinations of the disclosed embodiments may be used, while still employing the same basic underlying mechanisms and methodologies. The foregoing description, for purpose of explanation has been written with references to specific embodiments. However, the illustrative discussions above are not intended to be exhaustive or to limit the invention to the precise forms disclosed. Many modifications and variations are possible in view of the above teachings. The embodiments were chosen and described to explain the principles of the invention and their practical applications, and to enable others skilled in the art to best utilize the invention and various embodiments with various modifications as are suited to the particular use contemplated. It is understood that various features of the invention which are, for brevity, described in the context of a single embodiment, may also be provided separately or in any suitable subcombination.

What is claimed is:

1. A method for providing a permanent weight management program, comprising:
obtaining health related information of an individual,
obtaining at least one goal of the individual related to the health related information,
identifying health related habit information that is contrary to the at least one goal of the individual,
providing the individual with a permanent weight-management plan that includes at least one corrective action with respect to the identified health related habit information and a focus object, and
associating the at least one corrective action with the focus object so that the focus object provides a constant reminder to the individual to stay focused on making good lifestyle choices most of the time related to the at least one corrective action.

2. The method according to claim 1, wherein the health related information includes the weight of the individual and the at least one goal is weight loss for the individual.

3. The method according to claim 1, wherein the obtaining health related information of the individual comprises:
obtaining at least a portion of medical history of the individual,
obtaining at least one physical measurement of the individual, and
obtaining at least one health related habit of the individual.

4. The method according to claim 1, further comprising providing the individual with a journal to record at least one activity related to the health related information of the individual.

5. The method according to claim 1, wherein the object comprises a coin engraved with the word “focus”.

6. The method according to claim 1, wherein the permanent weight management plan includes providing the individual with vitamin and mineral information, water consumption information, or nutrition information.

7. The method according to claim 1, wherein the health related habit information includes food consumption of the individual or physical, activity of the individual.

8. The method according to claim 1, wherein the at least one corrective action includes one or more of the following: an eating plan, a meal selection plan, a meal preparation plan, an exercise plan, or a combination thereof.

9. The method according to claim 1, wherein the method includes:
providing a healthy eating plan consisting of a variety of nutritional foods in moderate proportions, or
guidance to help the individual make the lifestyle changes and learn skills required to manage their new healthy weight for life, or
a combination thereof.

10. The method according to claim 1, wherein the method includes:
providing personalized contact with the individual, or
providing weekly telephone calls with the individual, or
providing support and motivation thought mail and email contact, or some combination thereof.

11. The method according to claim 1, wherein the method includes teaching the individual one or more of the following:
sound nutritional practices such as what foods should be eaten on a regular basis in, order to insure good health, or
how to select and shop for high quality foods they need,
what foods to buy, or
how to select the best and freshest foods, or
how much food they need to purchase depending on how many people they intend to feed and how often they intend to go shopping, or
some combination thereof.

12. The method according to claim 3, wherein the at least one physical measurement comprises an image of the individual, a weight for the individual, and at least one measurement for the neck, waist, full hip, chest, thigh, calf or arm of the individual.

13. A method for providing permanent weight management for an individual, comprising:
obtaining at least a portion of medical history of an individual,
obtaining at least one physical measurement of the individual,
obtaining at least one health related habit of the individual,
obtaining at least one goal of the individual related to at least one of the medical, history, the at least one physical measurement, or the at least one health related habit of the individual,
identifying at least one health related habit of the individual that is contrary to the at least one goal, of the individual,
providing the individual with a permanent weight management plan that includes a journal to record at least one activity related to the at least one health related habit, at least one corrective action with respect to the health related habit and a focus coin, and
associating the at least one corrective action with the focus coin so that the focus coin provides a constant reminder to the individual to stay focused on making good lifestyle choices most of the time related to the at least one corrective action.

14. The method according to claim 13, wherein the health related information includes the weight of the individual and the at least one goal is weight loss for the individual.

15. The method according to claim 13, wherein obtaining at least one physical measurement of the individual comprises: obtaining at least one image of the individual, obtaining a weight for the individual, and obtaining a measurement for at least one body part of the individual selected from neck, waist, full hip, chest, thigh, calf or arm.

16. The method according to claim 13, wherein obtaining at least one health related habit of the individual comprises: obtaining information related to consumption of food items by the individual, and obtaining information related to at least one physical activity of the individual.

17. The method according to claim 13, wherein providing the individual with a permanent weight management plan comprises: providing the individual with vitamin and mineral information, providing the individual with water consumption information, and providing the individual with nutrition information.

18. The method according to claim 13, wherein the at least one corrective action includes one or more of the following: an eating plan, a meal selection plan, a meal preparation plan, an exercise plan, or a combination thereof.

19. The method according to claim 13, wherein the at least one corrective action is designed to reduce a number of times that the individual performs the at least one identified health related habit.

20. The method according to claim 13, wherein the journal is configured to receive information related to daily food intake, daily water intake, weight, physical measurements and comments of the individual.

21. A method for providing a permanent weight management program, comprising:
obtaining at least a portion of medical history of an individual,
obtaining at least one physical measurement of the individual,
obtaining at least one health related habit of the individual, wherein the at least one health related habit is food consumption by the individual, or physical activity of the individual, or both,
obtaining at least one goal of the individual related to at least one of the medical history, the at least one physical measurement, or the at least one health related habit of the individual, or some combination thereof,
identifying at least one health related habit of the individual that is contrary to the at least one goal of the individual,
providing the individual with a permanent weight management plan that includes a journal configured to receive information related to daily food intake, daily water intake, weight, physical measurements and comments of the individual, one or more corrective actions, including one or more of the following: an eating plan, a meal selection plan, a meal preparation plan, an exercise plan or a combination thereof, designed to impact the at least one health related habit of the individual that is contrary to the at least one goal of the individual, and a focus coin, and
associating the one or more corrective actions with the focus coin so that the focus coin provides a constant reminder to the individual to stay focused on making good lifestyle choices most of the time related to the one or more corrective actions.

22. A kit for providing a permanent weight management program for an individual, comprising:
a focus coin, and
an instruction sheet setting forth steps of the permanent weight management program, including:
obtaining a weight of the individual,
obtaining at least one goal related to weight loss for the individual,
identifying health related habit information that is contrary to the at least one goal of the individual,
providing the individual with at least one corrective action with respect to the health related habit information, and
associating the at least one corrective action with the focus coin so that the focus coin provides a constant reminder to the individual to stay focused on making good lifestyle choices most of the time related to the at least one corrective action.

23. The kit according to claim 22, wherein the kit further comprises:
a bathroom scale for the individual to weigh themselves, or
a kitchen food scale for the individual to weigh food they consume, or
a journal configured to receive information related to daily food intake, daily water intake, weight, physical measurements and comments of the individual, or
a pedometer configured for determining an amount of movement the individual makes, or
a tape measure for the individual to measure themselves,
or some combination thereof.

24. The kit according to claim 23, wherein the bathroom scale is configured to display the weight, a body fat percentage and a hydration level of the individual.

25. The method according to claim 1, wherein the method further comprises:
providing weekly contact for a predetermined period of time to keep the individual motivated, to remind the individual about the reasons why they need to lose weight and how weight loss will hopefully improve their health and the quality of their lives in the future, and to support the individual to feel that they are not alone and that they can get answers to their questions in a timely fashion.
